(19) United States
(12) Patent Application Publication
(10) Pub. No.: US 2009/0195381 A1
(43) Pub. Date: Aug. 6, 2009

(54) COMMUNICATION DEVICE ALERT APPARATUS

(75) Inventors: Daniel F. Bearer, JR., Hines, OR (US); Wendy E. Bull, Burns, OR (US)

Correspondence Address: Silicon Forest Patent Group;Paul J. Fordenbacher, 11876 NW Tyler Ct, Portland, OR, 97729, US

(73) Assignee: CELLPAL, LLC, Burnes, OR (US)

(21) Appl. No.: 12/424,665

(22) Filed: Apr. 16, 2009

Related U.S. Application Data
(63) Continuation of application No. PCT/US08/80406, filed on Oct. 18, 2008.
(60) Provisional application No. 61/001,360, filed on Oct. 31, 2007.

(51) Int. Cl. G08B 21/00

(52) U.S. Cl. 340/540

(57) ABSTRACT

In accordance with embodiments presented herein, an apparatus is provided that is suitable for producing an audible alert sound that is activated by a device sound produced by a communication device.

### RELATED APPLICATIONS

This application is a continuation application of and claiming priority to PCT patent application PCT/US08/80406, filed on Oct. 18, 2008, which is in its entirety incorporated herewith by reference, claiming priority to U.S. provisional patent application No. 61/001,360, filed on Oct. 31, 2007, which is in its entirety incorporated herewith by reference.

### FIELD

The embodiments presented herein relate to communication devices, and in particular, to apparatus and methods for alerting a user of the presence of a device sound produced by a communication device.

### BACKGROUND

As the use of communication devices, such as, but not limited to, cellular phones and email devices, become more widespread, users are becoming more dependent on them for staying connected with people and keeping current with events. It is common for users to keep their personal communication device close by so as to hear the audio alarm and/or feel the vibration that alerts the user of an incoming call, text message, or email. Although the loudness of the audio alarm may be adjustable, it is oftentimes not nearly loud enough to be heard from a distance or while in a different room from the user. The user, though, may not want to carry the device in their pocket or clipped to their belt all of the time. Therefore, the user may be at risk of missing a call or message during the time the user and the device are out of the range of hearing.

By way of example, more users are electing to use their cell phone as their only telephone service, foregoing the traditional land-line service. At the same time, although most homes are wired to provide phone service throughout the home, a call to a cell phone does not activate the home phone apparatus. As a result, and because of the relatively low volume of a cell phone audio alarm compared to a ringer of a typical land-line phone, it can be difficult to hear the audio alarm of the cell phone if the user happens to be in another part of the home or building.

### BRIEF DESCRIPTION OF THE DRAWINGS

Non-limiting and non-exhaustive embodiments will be described with reference to the following figures, wherein like reference numerals refer to like parts throughout the various figures unless otherwise specified.

FIG. 1 is a perspective view of an apparatus in accordance with an embodiment;

FIG. 2 is a schematic diagram of system electronics, comprising the microphone, the switch circuit, and the alert sound generating device in accordance with an embodiment;

FIG. 3 is a schematic diagram of system electronics, comprising the microphone, the switch circuit, and the alert sound generating device in accordance with another embodiment;

FIG. 4 is a schematic diagram of system electronics, comprising the microphone, the switch circuit, and the alert sound generating device in accordance with another embodiment;

FIG. 5 is a perspective view of an apparatus in accordance with another embodiment; and

FIG. 6 is a perspective view of an apparatus in accordance with another embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

Hereinafter, the phrase “communication device” refers to any device that is used for communication. Examples of a communication device include, but are not limited to, cellular (cell) telephone, email device, text message device, internet device, personal digital assistant (PDA), and any other wireless device capable of being used to communicate with others and capable of producing an audible sound, including vibration, otherwise referred to as a device sound. These are merely examples and the claimed subject matter is not limited thereto.

Hereinafter, the phrase “device sound” refers to any sound and/or vibration that is produced by a communication device. Examples of a device sound include, but are not limited to, the sound, tone, tune, ring tone, and/or vibration associated with, such as, but not limited to, an incoming call on a cellular phone, an incoming email on an email device, and/or an audible sound associated with an incoming call, message or alarm. These are merely examples and the claimed subject matter is not limited thereto.

Hereinafter, the phrase “alert sound” refers to a sound produced by embodiments of apparatus presented herein. In accordance with embodiments of apparatus, an alert sound is produced when a device sound is initially produced; that is, the device sound triggers the alert sound. Examples of an alert sound include, but are not limited to, any sound, tone, tune, ring tone, and/or a reproduction or amplification of the device sound. These are merely examples and the claimed subject matter is not limited thereto.

In accordance with embodiments presented herein, an apparatus is provided that is suitable for producing an alert sound that is activated by a device sound produced by a communication device. The alert sound may be of sufficient volume so as to be heard by a user that is at a significant distance from the communication device such that the user would otherwise not hear the device sound.

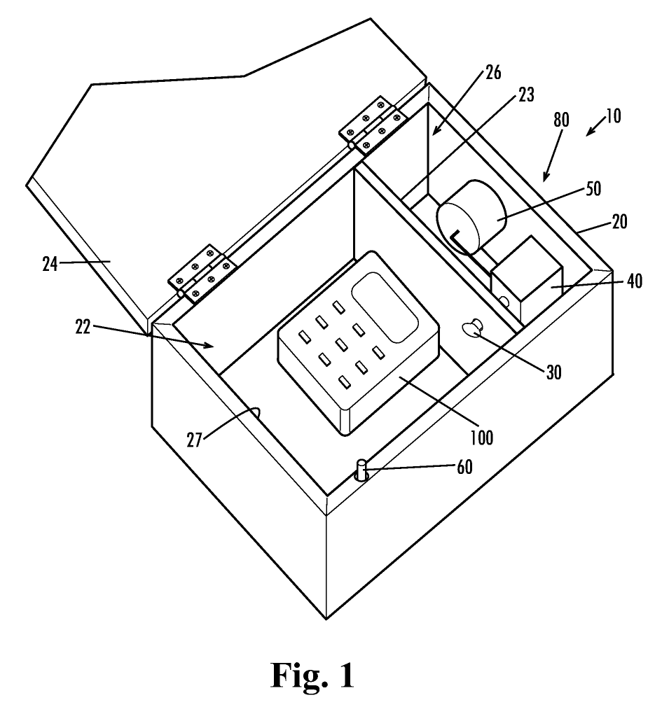

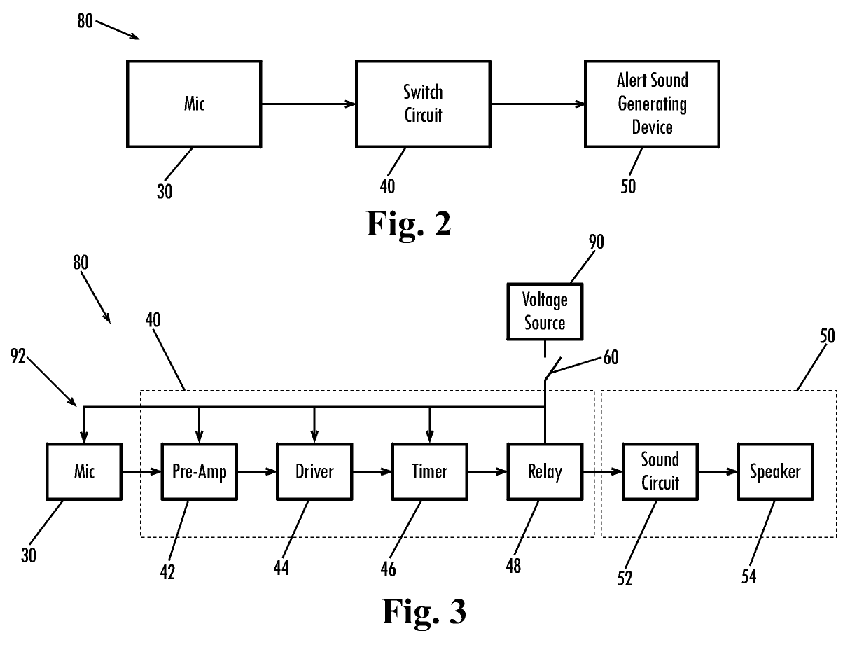

FIG. 1 is a perspective view of an apparatus 10 in accordance with an embodiment. The apparatus 10 comprises a housing 20, a microphone 30, a switch circuit 40, and an alert sound generating device 50. The microphone 30, switch circuit 40, and alert sound generating device 50, among any other electrical components associated therewith, are referred to collectively as system electronics 80 and shown schematically in FIG. 2. The microphone 30 is operable to be sound responsive and capable, upon detection of a device sound, of generating an electrical output signal. The switch circuit 40 is operable to be responsive to the electrical output signal of the microphone 30 in response to the device sound. The alert sound generating device 50 is operable to be actuated by the switch circuit 40 and, when actuated, is operable for producing an alert sound.

Further, FIG. 1 illustrates a communication device 100 placed within the apparatus 10 by way of example of a method of using the apparatus 10. Wherein the communication device 100 produces a device sound, the microphone 30 detects the device sound, which in turn communicates a signal to the switch circuit 40, which in turn activates the alert sound generating device 50 so as to produce an alert sound.

The housing 20 defines a device cavity 22 having a cavity opening 27 that may be enclosed by a closure element 24, such as a lid or door. The device cavity 22 is of a predetermined size suitable for containing a communication device 100 therein. A partition 23 defines an electronics cavity 26 wherein the electronics 80 may be separated from the communication device 100. It is appreciated that the packaging of the system electronics 80 may be implemented in many suitable ways so as to contain and protect the system electronics 80. For example, the system electronics 80 may be housed in a subhousing enclosed by an access panel that provides only limited user access. Embodiments of apparatus 10 as exemplified by FIG. 1 provide that the communication device 100 may be contained within the housing 20 while remaining conveniently accessible by a user for placement therein or removal therefrom.

The housing 20 and the closure element 24 are operable so as to contain the communication device 100 within the cavity 22. In accordance with an embodiment, the housing 20 and closure element 24 are adapted to isolate the microphone 30 from ambient sounds that are external of the housing 20 while allowing the microphone 30 to detect device sounds generated by the communication device 100. Ambient sound isolation may be necessary to prevent false alarms, that is, to prevent the alert sound generating device 50 from activating caused by ambient sounds not associated with the communication device 100.

The system electronics 80 requires a voltage source for operation as is well understood in the art of electronics. A voltage source is not shown for convenience in FIG. 1 but is shown in FIG. 3 as voltage source 90. A voltage source may be provided to the apparatus 10, such as, but not limited to, by a battery and/or by a power chord to an A.C. or D.C. source.

In the following example, a communication device 100 in the form of a cell phone is described as being used with the apparatus 10. This is only an example and the embodiments of the apparatus 10 are not to be construed as limited thereby. A user places a cell phone into the device cavity 22 of the apparatus 10. The closure element 24 is displaced over the cavity opening 27 of the device cavity 22 effectively enclosing the cell phone 100 inside. Closure of the closure element 24 over the cavity opening 27 at least partially isolates the microphone 30 from ambient sound. Ambient sound attenuation may prevent unintended triggering of an alert sound caused by ambient sounds.

The apparatus 10 is electrically activated by applying a voltage to the system electronics 80. At this point, the apparatus 10 is considered to be in “stand-by mode” wherein the apparatus 10 is ready to response to a device sound. The system electronics 80 is operable such that the microphone 30 may be energized so as to detect a device sound generated by the cell phone 100.

While in stand-by mode, the apparatus 10 is electrically activated such that the switch circuit 40 may respond to an electrical signal from the microphone 30 so as to output an electrical signal to the sound generating device 50. The alert sound generating device 50 is operable to produce an alert sound when the switch circuit 40 outputs an electrical signal thereto, in other words, activates the alert sound generating device 50. As will be described further below, the alert sound generating device 50 will produce an alert sound for a predetermined period of time.

In accordance with an embodiment, the apparatus 10 may be connected to a voltage source and energized at all times. In accordance with another embodiment, the apparatus is coupled to a voltage source by the control of a switch.

Referring again to FIG. 1, in accordance with an embodiment, the apparatus 10 further comprises a switch 60, such as but not limited to a pressure-sensitive switch. The switch 60 is in electrical communication between a voltage source and the switch circuit 40. The switch 60 is operable to open and close the electrical circuit between the voltage source and the switch circuit 40 by the opening and closing, respectively, of the closure element 24.

In the embodiment of FIG. 1, the switch 60 is disposed adjacent the cavity opening 27 and proximate the closure element 24 such that when the closure element 24 is disposed over the cavity opening 27 so as to close the cavity 22, the closure element 24 abuts the switch 60, which in-turn closes the electrical circuit between the voltage source and the switch circuit 40. This closing of the electrical circuit electrically energizes the system electronics 80.

And, likewise, when the device cavity 22 is opened by moving the closure element 24 away from the cavity opening 27, the closure element 24 is no longer abutting the switch 60 whereby opening the circuit between the power source and the switch circuit 40. This opening of the electrical circuit de-energizes the system electronics 80 and renders the alert sound generating device 50 silent if it had been activated and/or takes the apparatus out of stand-by mode. The opening and closing of the switch 60 is operative to reset the apparatus 10 placing the apparatus 10 in standby-mode once again after closing. It is understood that the switch 60 is but one example, and that any type of switch operable to close an electrical circuit upon closing the cavity opening 27 with a closure element 24 is suitable for the particular purpose.

In yet another embodiment, apparatus 10 comprises a switch (not shown) such as a button switch, or toggle switch, but not limited thereto, that is not necessarily associated with the closure element 24. For example, an on/off/reset switch may be provided on the exterior of the housing 20 for manually activating/deactivating, respectively, the apparatus 10, irrespective of the operation of the closure element 24.

In accordance with an embodiment, the system electronics 80 is operable to produce an alert sound only when a device sound is produced. In accordance with other embodiments, the system electronics 80 is operable to produce an alert sound for a period of time after the device sound has been silenced. In various embodiments, the period of time that the alert sound is produced is controlled by, such as, but not limited to, a timer and/or manual control of the user such as by a switch. In other embodiments, the system electronics 80 is operable such that after an alert sound is produced, the system electronics 80 resets to a stand-by state so as to sense the next occurrence of the production of a device sound.

FIG. 3 is a schematic diagram of an embodiment of system electronics 80, comprising a microphone 30, a switch circuit 40, and an alert sound generating device 50. It is understood that many electrical circuit configurations may be operable for the intended purpose of the system electronics 80, and the following implementation is only one example, and not limited thereto. The system electronics 80 may be powered, for example, but not limited to, by a D.C. or a rectified A.C. voltage source 90, to provide a voltage potential to the system electronics 80. The switch circuit 40 comprises a preamplifier 42, a driver 44, a timer 46, and a relay 48. An electrical output of the microphone 30 is coupled to an electrical input of the preamplifier 42, such that an electrical signal from the microphone 30 may be communicated to the preamplifier 42. The signal from the microphone 30 may be amplified and sent to the driver 44. The driver 44 is operable to provide an electrical signal to the timer 46. The timer 46 is operable to activate the relay 48 which in-turn communicates an electrical signal to the alert sound generating device 50.

The alert sound generating device 50 comprises a sound circuit 52 in electrical communication with a speaker 54. The alert sound generating device 50 is operable to produce an audible alert sound suitable to alert the user.

The driver 44 is operable to control the signal from the preamplifier 42 to the timer 46. Such control includes, but is not limited to, one or more of amplification, filtering, frequency attenuation, and activation sensitivity adjustment.

The timer 46 is operable to electrically energize and maintain the relay 48 in an energized state for a predetermined period of time. The relay 48 includes a switch (not shown) whose contacts are normally open. When the relay 48 is energized, the switch contacts close to close the circuit to the alert sound generating device 50. After a predetermined time interval, the timer 46 opens the electrical connection to the relay 48 causing the relay 48 to open the circuit to the alert sound generating device 50 to silence the alert sound after a predetermined time interval. The duration of the time interval that the timer 46 energizes the relay 48 may be user settable to, for example, coincide with a response time desired by the user. For example, a five-second duration may be sufficient to alert the user wherein another user may need a 30 second duration.

It is understood that the timer 46 may be implemented in many ways known in the art. The timer 46 may be implemented as a mechanical timer, a discharge capacitor, a microprocessor timing circuit, among many others suitable for the particular purpose.

The switch circuit 40 may further comprise an electronic filter (not shown) between the preamplifier 42 and the driver 44. The electronic filter may be operable to filter out selected frequencies from the signal produced by the microphone 30 such that those frequencies do not activate the relay 48. The microphone output may be filtered to remove all unwanted frequencies such that the relay 48, and thus the alert sound generating device 50, is activated by device sounds of a predetermined desired frequency. An example of an electronic filter is a differentiating network known in the art, including series resistors and a parallel capacitor. Such a filter may function to by-pass all unwanted ambient frequency signals away from the relay 48 such as those frequencies generated by the sounds of a doorbell, chimes of a clock, among others, such that those ambient sounds do not active the alert sound generating device 50.

The alert sound generating device 50 may produce any audio sound suitable for a particular purpose. In an embodiment, the alert sound generating device 50 produces a continuous sound. In another embodiment, the alert sound generating device 50 produces a discontinuous repeating sound.

In another embodiment, the alert sound generating device 50 amplifies the device sound produced by the communication device 100. In this embodiment, the system electronics 80 comprises a microphone 30, a switch circuit 40 including an amplifier, and an alert sound generating device 50 including a speaker.

The alert sound generating device 50 may be any device suitable for the particular purpose. In embodiments, the alert sound generating device 50 may be an electro-mechanical device such as a buzzer, a bell, or vibrator, but not limited thereto. In other embodiments, the alert sound generating device 50 may be an amplifier and speaker for producing an amplified alert sound of the device sound detected by the microphone 30. In yet other embodiments, the alert sound generating device 50 may be a tone generator and speaker. In a particular implementation, a tone generator may be a pulse code modulated sound source known in the art for producing, or reproducing, a desired analog sound. Many implementations of the alert sound generating device 50 are anticipated.

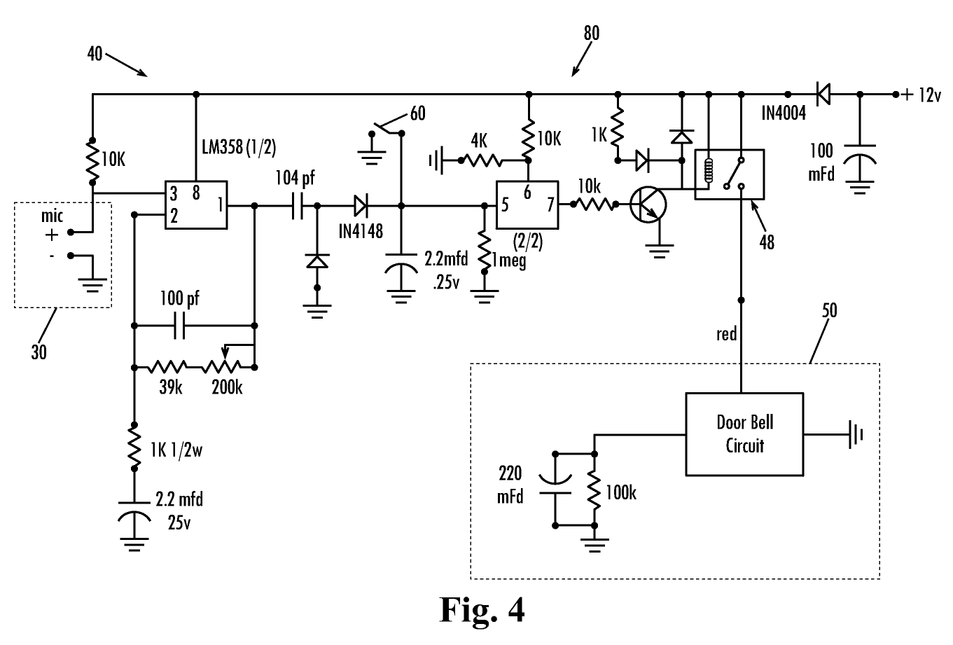

FIG. 4 is a schematic of an embodiment of the system electronics 80, comprising a microphone 30, switch circuit 40, and alert sound generating device 50. The switch circuit 40 is operable to receive an electrical signal from the microphone 30 and to close an electrical circuit to energize the alert sound generation device 50 in response to the microphone 30 detecting a device sound. The switch circuit 40 illustrated in FIG. 4 is substantially similar to that of the K126 Mini-VOX and Relay Electronic Kit, K126 (KITSRUS, Hong Kong). This voice-operated circuit closes an electrical circuit as long as the microphone 30 picks up sounds above a user selectable level. The relay 48 opens the electrical circuit after the sound falls below a predetermined threshold level for about 3 seconds. The Mini-VOX and Relay is based on a circuit that is well known in the art. The circuit has been improved by including a Koa potentiometer operable to adjust the sensitivity of the microphone 30. The relay 48 stays energized closing the circuit for a number of seconds depending on components used, then de-energizes to open the circuit. Different time values may be realized by using different value electrical components.

The function of the circuit components of FIG. 4 not specifically mentioned perform conventional circuit operations such as filtering, providing load resistance, the attainment of biasing potentials, as is well understood by those skilled in the art. Likewise, the value of the individual electrical components will be in conformity with desired circuit operation.

As will be apparent, in embodiments, the microphone 30, the switch circuit 40, and the alert sound generation device 50, as well as all electrical connections of the apparatus 10 as installed, may be built within the housing 20 and hidden from view. In other embodiments, the alert sound generation device 50, or a portion thereof, such as a speaker 54, may be disposed outside of and/or away from the housing 20, such as in another room of a building to ensure that the user is alerted when at a distance from the housing 20. Further, in yet other embodiments, the apparatus 10 may comprise a plurality of alert sound generation devices 50 that may be distributed throughout a dwelling, for example.

In yet other embodiments, the apparatus 10 may further comprise a wireless transmitter (not shown) operable to transmit a signal to an alert sound generation device 50 comprising a wireless receiver operable to receive such signal to active the alert sound generation device 50. As such, the placement of the alert sound generation device 50 may be made more suitable to the user.

Again, it is appreciated that many electrical circuit configurations may be operable for the intended purpose of the system electronics 80. In an embodiment, the system electronics 80 comprises electronic components coupled to a printed circuit board. The electronic components may be, for example, discrete and/or integrated components as is well known in the art.

It is understood that embodiments of system electronics 80 are anticipated that allow the user to adjust many of the parameters of the electronic components. Such adjustments include, but are not limited to, the volume of the alert sound generation device, the sensitivity of the microphone, the duration of activation of the alert sound generation device, and the type of tone or tones generated by the alert sound generation device.

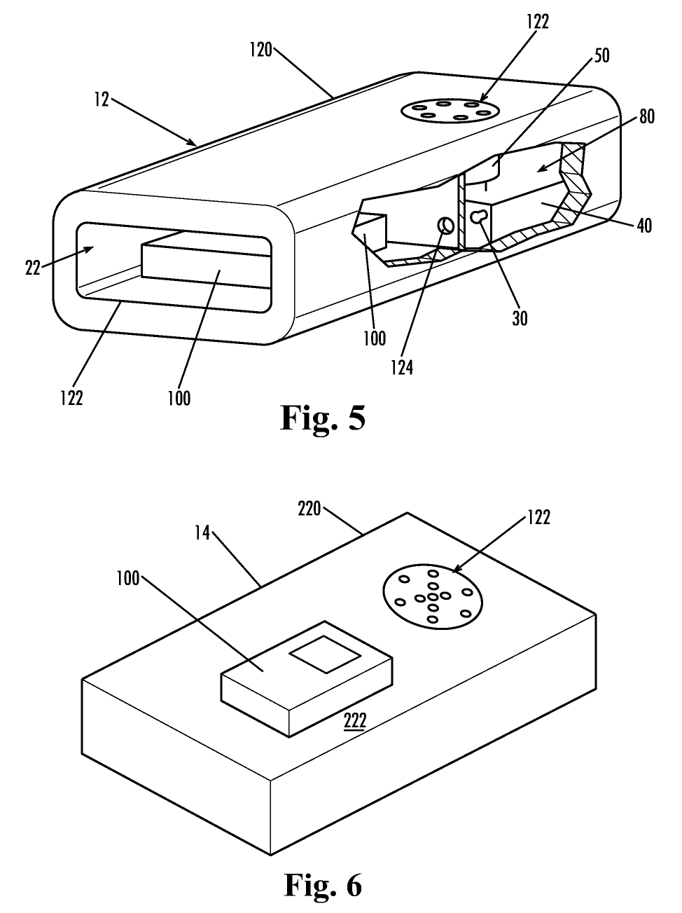

FIG. 5 is a perspective partially cut-away view of an apparatus 12 in accordance with another embodiment. The apparatus 12 is substantially similar in function as the embodiment of the apparatus 10 of FIG. 1, and similarly comprises a housing 120, a microphone 30, a switch circuit 40, and an alert sound generating device 50. The microphone 30, switch circuit 40, and alert sound generating device 50, among any other electrical components associated therewith, are referred to collectively as system electronics 80 and which is contained with the housing 120. The housing 120 defines an opening 122 to a device cavity 22 into which a communication device 100 may be placed.

The system electronics 80 are contained within the housing 120. The microphone 30 is operable to detect device sounds via a first aperture 124. The alert sound generating device 50 is operable to produce an alert sound through a second aperture 122 such that the user may hear it.

In use, the communication device 100 is relatively easily placed within and removed from the device cavity 22. The communication device 100 may be placed within the device cavity 22 and adjacent the first aperture 124 such that the microphone 30 may detect a device sound. The cavity 22 having a property of depth assists in ambient sound suppression coming from outside of the housing 122.

In another embodiment, the system electronics 80 may be operable to be tuned to respond to a specific frequency of device sound associated with the communication device 100 but not necessary associated with ambient sounds. In this embodiment, it may not be necessary to sound isolate the microphone 30 from the ambient sounds. As such, the housing may not necessarily have a closure element 24. The communication device 100 is caused to produce a sound of a predetermined frequency operable to activate the alert sound generating device 50.

FIG. 6 is a perspective view of an apparatus 14 in accordance with another embodiment. The apparatus 14 is substantially similar in function as the embodiment of the apparatus 10 of FIG. 1, and similarly comprises a housing 220 and system electronics (not shown), substantially similar to the system electronics 80 of FIG. 1, and which is contained with the housing 220. The housing 220 defines a device surface 222 onto which a communication device 100 may be placed. In use, the communication device 100 may be placed onto the device surface 222.

The system electronics are contained within the housing 220. A microphone (not shown), substantially similar to the system electronics 80 of FIG. 1, is operable to detect device sounds through the housing 220. The alert sound generating device (not shown) is operable to produce an alert sound through a second aperture 122 such that the user may hear it.

In another embodiment, the device surface 222 comprises a shallow depression (not shown) operable to prevent the communication device 100 from moving off of the device surface 222 such as might occur where the communication device 100 is set to vibrate as a device sound.

The embodiment of FIG. 6 may be particularly suitable for a communication device 100 set to vibration mode. The microphone may be operable to not only detect the sound of the vibrations against the housing 220 but also detect the physical vibrations transmitted through the housing 220. In an embodiment, the system electronics may be operable to only detect physical vibration as a device sound and therefore the chance for ambient sound to trigger an alert sound is subsequently reduced.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A communication device alert apparatus for use with a communication device that is operable to produce a device sound, comprising:
a housing; and
system electronics operable to produce an alert sound in response to a device sound, at least a portion of the system electronics contained within the housing.

2. The apparatus of claim 1, wherein the system electronics comprises:
a microphone;
a switch circuit; and
an alert sound generating device, the microphone is operable to be sound responsive and capable, upon detection of a device sound, of generating an electrical output signal, the switch circuit is operable to be responsive to the electrical output signal of the microphone in response to the device sound, the alert sound generating device is operable to be actuated by the switch circuit and, when actuated, is operable for producing an alert sound.

3. The apparatus of claim 2, wherein the housing comprises a closure element, the housing defining a device cavity having a cavity opening that may be enclosed by the closure element, the device cavity is of a predetermined size suitable for containing the communication device therein.

4. The apparatus of claim 3, wherein the closure element and device cavity cooperate to substantially isolate the microphone from ambient sound that may be present outside of the housing when the closure element is adjacent to and covering the cavity opening.

5. The apparatus of claim 3, wherein the system electronics further comprises a switch operable to open and close an electrical circuit between a voltage source and the system electronics by the opening and closing, respectively, of the closure element.

6. The apparatus of claim 3, wherein the system electronics further comprises a switch disposed adjacent the cavity opening and proximate the closure element such that when the closure element is disposed over the cavity opening so as to close the cavity, the closure element abuts the switch, which in-turn closes an electrical circuit between a voltage source and the switch circuit.

7. The apparatus of claim 2, wherein the system electronics further comprises a switch operable to open and close an electrical circuit between a voltage source and the system electronics.

8. The apparatus of claim 3, wherein the switch circuit comprises a timer operable to control the alert sound generation device and therefore control the duration of an alert sound.

9. The apparatus of claim 2, wherein the alert sound generating device comprises a sound circuit in electrical communication with a speaker.

10. The apparatus of claim 2, wherein the system electronics further comprises an electronic filter operable to filter out selected frequencies from the signal produced by the microphone such that those frequencies do not activate the alert sound generating device.

11. The apparatus of claim 2, wherein the system electronics further comprises
a sensitivity control operable to adjust the magnitude of the loudness of sound necessary to trigger the production of the alert sound.

12. The apparatus of claim 2, wherein the system electronics further comprises
a wireless transmitter operable to transmit a signal to an alert sound generation device comprising a wireless receiver operable to receive such signal to active the alert sound generation device, the alert sound generation device operable to be remote from the housing.

13. The apparatus of claim 2, wherein the housing defines a device cavity having a cavity opening, the device cavity is of a predetermined size suitable for containing at least a portion of the communication device therein.

14. The apparatus of claim 2, wherein the housing defines a device surface onto which a communication device may be placed, the system electronics is contained within the housing, the microphone is operable to detect device sounds and/or vibrations through the housing.

15. The apparatus of claim 1, wherein the system electronics is operable to produce an alert sound that is an amplification of the device sound.

16. The apparatus of claim 1, wherein the system electronics comprises:
a microphone; and
an alert sound generating device, the microphone operable for producing an electrical output signal to the alert sound generating device, and the alert sound generating device operable for producing an alert sound in response to the electrical output signal.

17. The apparatus of claim 1, wherein the system electronics comprises:
a microphone;
a switch circuit; and
an alert sound generating device, the microphone operable for producing an electrical output signal to the switch circuit in response to detecting a device sound, the switch circuit operable for activating the alert sound generating device in response to receiving an electrical output signal from the microphone, the alert sound generating device operable for producing an alert sound in response to being activated by the switch circuit.

18. A communication device alert apparatus for use with a communication device that is operable to produce a device sound, comprising:
a housing; and
system electronics, at least a portion of which is contained within the housing, wherein the system electronics comprises:
a microphone;
a switch circuit; and
an alert sound generating device, the microphone operable for producing an electrical output signal to the switch circuit operable in response to detecting a device sound, the switch circuit for activating the alert sound generating device in response to receiving an electrical output signal from the microphone, the alert sound generating device operable for producing an alert sound in response to being activated by the switch circuit.

19. The apparatus of claim 18, wherein the housing comprises a closure element, the housing defining a device cavity having a cavity opening that may be enclosed by the closure element, the device cavity is of a predetermined size suitable for containing the communication device therein.

20. The apparatus of claim 19, wherein the closure element and device cavity cooperate to substantially isolate the microphone from ambient sound that may be present outside of the housing when the closure element is adjacent to and covering the cavity opening.

21. The apparatus of claim 19, wherein the system electronics further comprises a switch operable to open and close an electrical circuit between a voltage source and the system electronics by the opening and closing, respectively, of the closure element.

22. The apparatus of claim 19, wherein the system electronics further comprises a switch disposed adjacent the cavity opening and proximate the closure element such that when the closure element is disposed over the cavity opening so as to close the cavity, the closure element is operable to abut the switch, which in-turn closes an electrical circuit between a voltage source and the switch circuit.

23. The apparatus of claim 18, wherein the system electronics further comprises a switch operable to open and close an electrical circuit between a voltage source and the system electronics.

24. The apparatus of claim 18, wherein the switch circuit comprises a timer operable to control the alert sound generation device and therefore control the duration of an alert sound.

25. The apparatus of claim 18, wherein the alert sound generating device comprises a sound circuit in electrical communication with a speaker.

26. The apparatus of claim 18, wherein the system electronics further comprises an electronic filter operable to filter out selected frequencies from the signal produced by the microphone such that those frequencies do not activate the alert sound generating device.

27. The apparatus of claim 18, wherein the system electronics further comprises a sensitivity control operable to adjust the magnitude of the loudness of sound necessary to trigger the production of the alert sound.

28. The apparatus of claim 18, wherein the system electronics further comprises a wireless transmitter operable to transmit a signal to an alert sound generation device comprising a wireless receiver operable to receive such signal to active the alert sound generation device, the alert sound generation device operable to be remote from the housing.

29. The apparatus of claim 18, wherein the housing defines a device cavity having a cavity opening, the device cavity is of a predetermined size suitable for containing at least a portion of the communication device therein.

30. The apparatus of claim 18, wherein the housing defines a device surface onto which a communication device may be placed, the system electronics is contained within the housing, the microphone is operable to detect device sounds and/or vibrations through the housing.

31. A communication device alert apparatus for use with a communication device that is operable to produce a device sound, comprising:
a housing operable for containing the communication device therein; and
system electronics operable to produce an alert sound in response to a device sound, at least a portion of the system electronics contained within the housing, wherein the alert sound may be of sufficient volume so as to be heard by a user that is at a significant distance from the communication device that the user would otherwise not hear the device sound.
